(19) United States
(12) Patent Application Publication
(10) Pub. No.: US 2006/0029889 A1
(43) Pub. Date: Feb. 9, 2006

(54) Method to fabricate diffractive optics

(76) Inventor: Tak Kui Wang, Saratoga, CA (US)

Correspondence Address: AGILENT TECHNOLOGIES, INC;Intellectual Property Administration, Legal Department, DL429, P.O. Box 7599, Loveland, CO, 80537-0599, US

(21) Appl. No.: 10/913,745

(22) Filed: Aug. 6, 2004

(51) Int. Cl. G02B 5/18

(52) U.S. Cl. 430/321; 264/2.5

(57) ABSTRACT

A method for making a diffractive optical element (DOE) includes forming a first mask that exposes a portion of a substrate, depositing a first film over the substrate, removing the first mask to form a first optical element on the substrate, forming a second mask that exposes a portion of the first optical element, depositing a second film over the substrate, and removing the second mask to form a second optical element. A method for making a DOE includes patterning a first material to expose a portion of a substrate, depositing a first film over the substrate, planarizing the first film and the first material to form a first optical element, patterning a second material to expose a portion of the first optical element, depositing a second film over the substrate, and planarizing the second film and the second material to form a second optical element.

### DESCRIPTION OF RELATED ART

U.S. Pat. No. 5,218,471 (“Swanson et al.”) describes a method for fabricating a diffractive optical element (DOE). Specifically, Swanson et al. describes successive etching after applying masks. The etch depth of each mask is binary weighted. With such a method, 2ˆN of phase levels can be achieved using only N masks.

### SUMMARY

In one embodiment of the invention, a method for making a diffractive optical element (DOE) includes forming a first mask that exposes a portion of a substrate, depositing a first film over the substrate, removing the first mask to form a first optical element on the substrate, forming a second mask that exposes a portion of the first optical element, depositing a second film over the substrate, and removing the second mask to form a second optical element.

In another embodiment of the invention, a method for making a DOE includes patterning a first material to expose a portion of a substrate, depositing a first film over the substrate, planarizing the first film and the first material to form a first optical element, patterning a second material to expose a portion of the first optical element, depositing a second film over the substrate, and planarizing the second film and the second material to form a second optical element.

### BRIEF DESCRIPTION OF THE DRAWINGS

FIGS. 1A, 1B, 1C, 1D, 1E, and 1F illustrate cross-sections of structures formed in a method for fabricating a diffractive optical element in one embodiment of the invention.

FIGS. 1G, 1H, 1I, and 1J illustrate cross-sections of structures formed in a continuation of the method in FIGS. 1A to 1F in one embodiment of the invention.

FIGS. 2A, 2B, 2C, 2D, 2E, and 2F illustrate cross-sections of structures formed in a method for fabricating a diffractive optical element in one embodiment of the invention.

FIGS. 2G, 2H, 21, and 2J illustrate cross-sections of structures formed in a continuation of the method in FIGS. 2A to 2F in one embodiment of the invention.

FIGS. 3A, 3B, 3C, 3D, 3E, 3F, and 3G illustrate cross-sections of structures formed in a method for fabricating a diffractive optical element in one embodiment of the invention.

FIGS. 3H, 31, 3J, and 3K illustrate cross-sections of structures formed in a continuation of the method in FIGS. 3A to 3E in one embodiment of the invention.

Use of the same reference numbers in different figures indicates similar or identical elements. The figures are not drawn to scale and are for illustrative purposes only.

### DETAILED DESCRIPTION

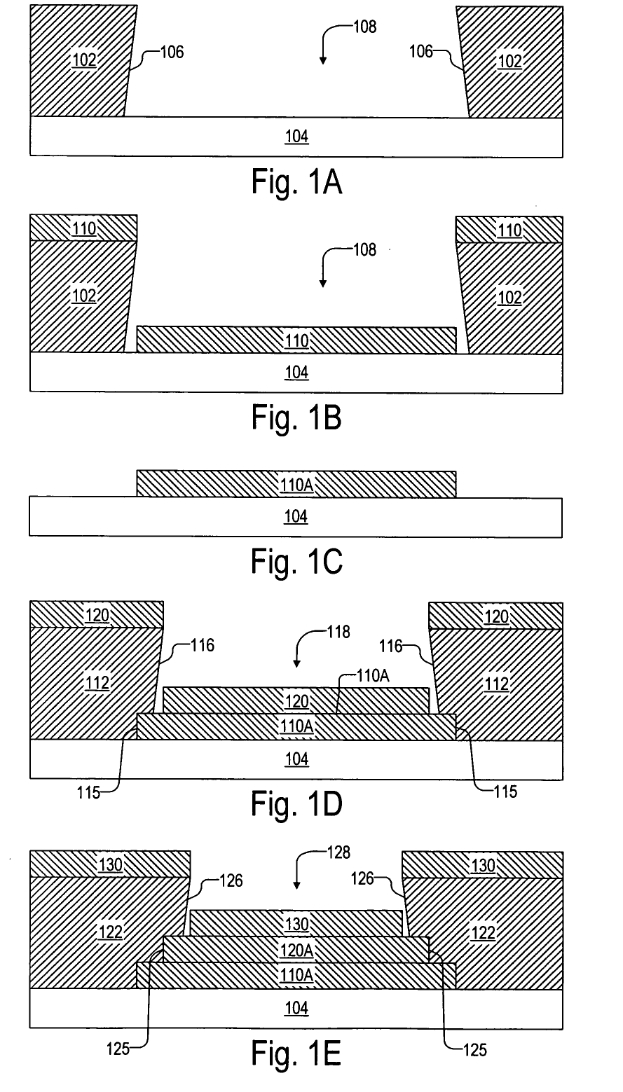

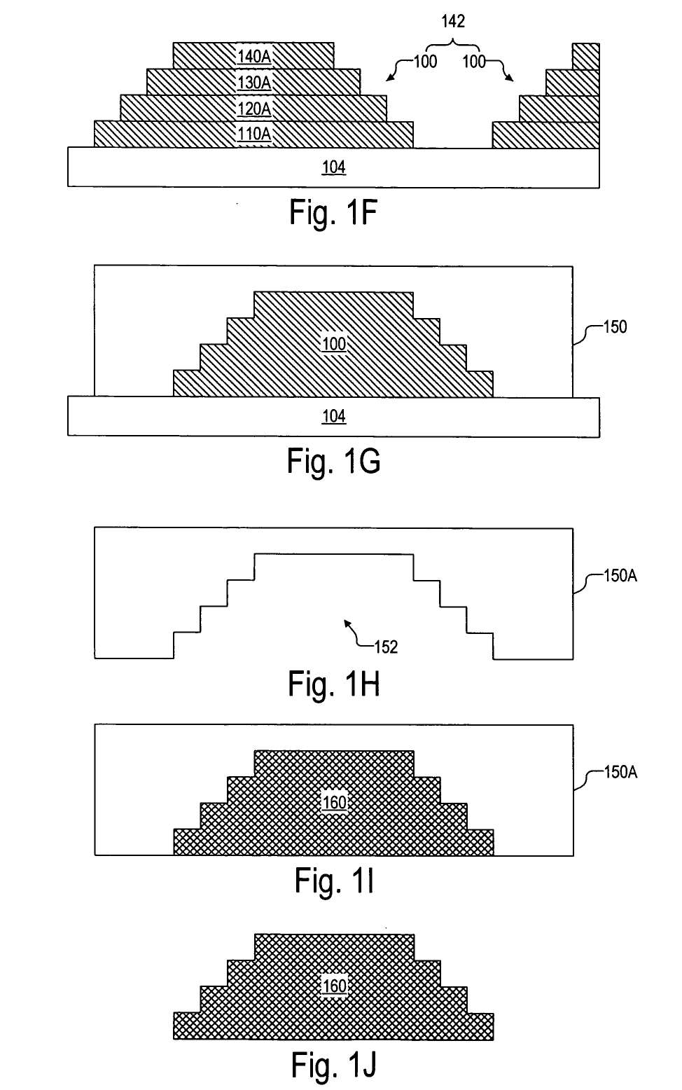

FIGS. 1A to 1E illustrate a lift-off method for fabricating a diffractive optical element (DOE) in one embodiment of the invention.

In FIG. 1A, a lift-off mask 102 is formed over a substrate 104. Mask 102 may have sidewalls 106 with a re-entry profile. Sidewalls 106 define a window 108 that exposes a portion of substrate 104. Substrate 104 can be a silicon substrate and mask 102 can be a photoresist that is spun on, exposed, and developed.

In FIG. 1B, a thin film 110 is deposited over substrate 104. As a result, thin film 110 collects on mask 102 and the exposed portion of substrate 104. Thin film 110 can be a dielectric (e.g., Si, SiO₂, or TiO₂) deposited by electron beam (e-beam) evaporation or sputtering. When a thin film is deposited by evaporation, the thickness can be controlled with great accuracy (e.g., within 10% of the target thickness) using in-situ thickness monitors in the evaporating equipment.

In FIG. 1C, mask 102 is removed to lift off the thin film collected thereon and to leave behind the thin film collected on substrate 104. The remaining thin film forms an optical element 110A. Mask 102 can be chemically removed by a resist stripper.

In FIG. 1D, a lift-off mask 112 is formed over substrate 104. Mask 112 may have sidewalls 116 with a re-entry profile. Sidewalls 116 define a window 118 that exposes a portion of optical element 110A. Mask 112 also covers sidewalls 115 of optical element 110A to provide the proper offset for another optical element to be formed on top of optical element 110A.

A thin film 120 is deposited over substrate 104. As a result, thin film 120 collects on mask 112 and the exposed portion of optical element 110A. Mask 112 is removed to lift off the thin film collected thereon and to leave behind the thin film collected on optical element 110A. The remaining thin film 120 forms an optical element 120A (FIG. 1E).

In FIG. 1E, a lift-off mask 122 is formed over substrate 104. Mask 122 may have sidewalls 126 with a re-entry profile. Sidewalls 126 define a window 128 that exposes a portion of optical element 120A. Mask 122 also covers sidewalls 125 of optical element 120A to provide the proper offset for another optical element to be formed on top of optical element 120A.

A thin film 130 is deposited over substrate 104. As a result, thin film 130 collects on mask 122 and the exposed portion of optical element 120A. Mask 122 is removed to lift off the thin film collected thereon and to leave behind the thin film collected on optical element 120A. The remaining thin film 130 forms an optical element 130A (FIG. 1F).

As described above, the same process can be repeated a number of times to create a stack of optical elements having the desired thicknesses and shapes.

FIG. 1F illustrates a structure 100 having optical elements 110A, 120A, 130A, and 140A formed from the process described above. In one embodiment, structure 100 is a DOE such as a transmissive grating. Of course a reflective grating can be made if reflective thin films are used.

In another embodiment, structure 100 is a mold for fabricating a DOE using a conventional ultraviolet (UV) replication process.

In another embodiment, one or more structures 100 form a mold 142 for fabricating a DOE using a conventional injection molding process. In this embodiment, substrate 104 is a metal substrate and optical elements 110A, 120A, 130A, and 140A are made from metal thin films (e.g., Ni).

In another embodiment, structure 100 forms an imprint mask for fabricating a DOE using conventional step and flash imprint lithography. In this embodiment, substrate 104 is a metal substrate and optical elements 110A, 120A, 130A, and 140A are made from metal thin films (e.g., Ni).

In another embodiment illustrated in FIGS. 1G to 1J, structure 100 is a model for a mold used to fabricate a DOE. In this embodiment, substrate 104 is a metal substrate and optical elements 110A, 120A, 130A, and 140A are made from metal thin films (e.g., Cu, Au, or W). In FIG. 1G, a layer of metal 150 is formed over model 100 by plating model 100 with metal 150 (e.g., Ni).

In FIG. 1H, model 100 and substrate 104 are removed to form a mold 150A. Mold 150A defines a cavity 152 having the form of a DOE. Model 100 and substrate 104 can be removed by chemical wet etches. In FIG. 1I, a material is deposited in mold 150A to form a DOE 160. In FIG. 1J, DOE 160 is separated from mold 150A and ready to be used. Depending on its material, DOE 160 can be a transmissive or reflective grating.

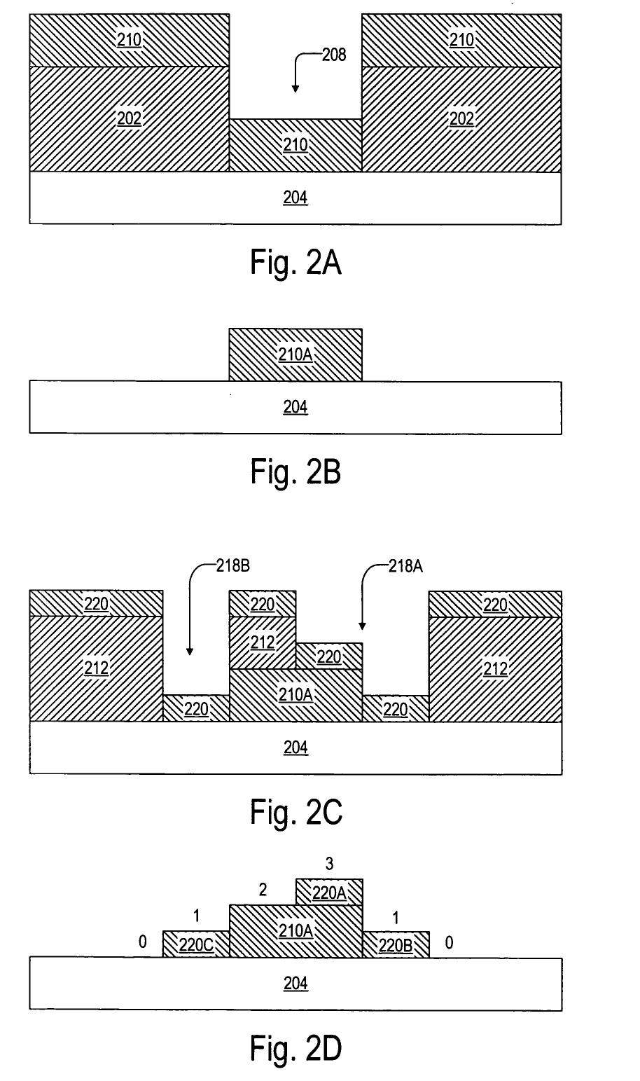

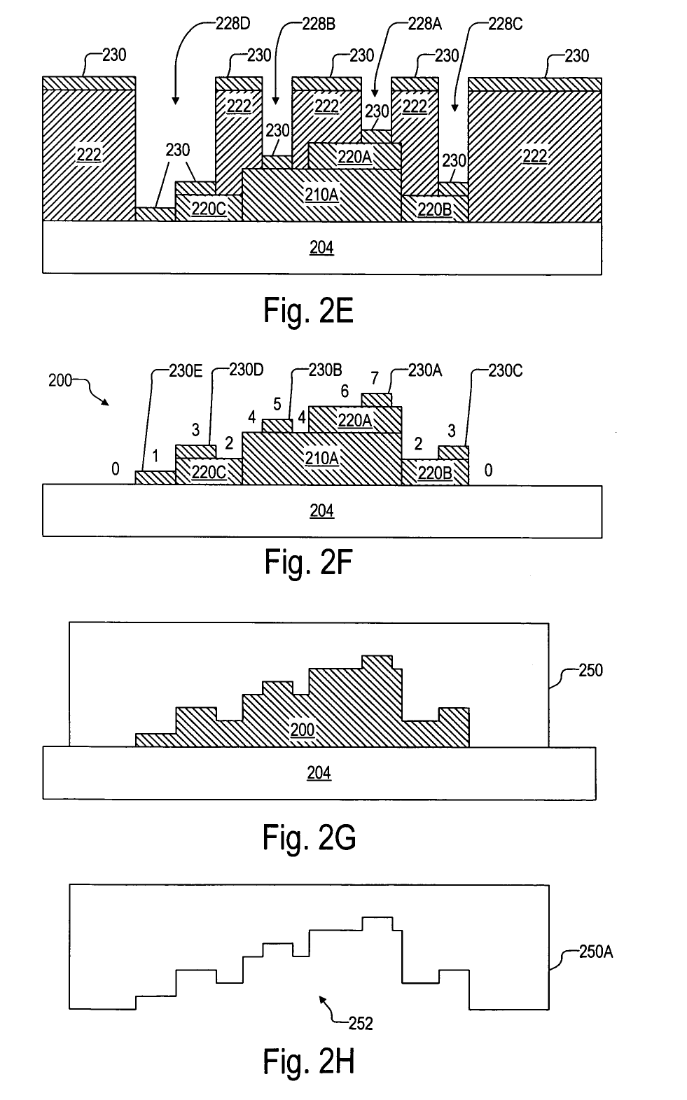

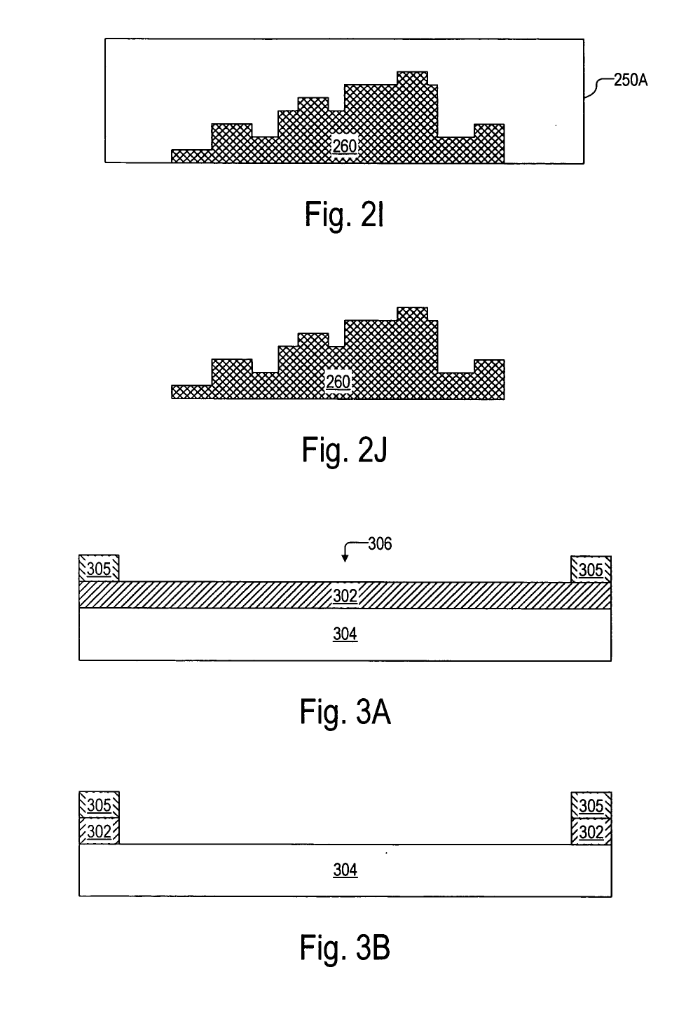

FIGS. 2A to 2F illustrate a lift-off method for fabricating a DOE using binary weighted masks in one embodiment of the invention.

In FIG. 2A, a lift-off mask 202 is formed over a substrate 204. Mask 202 defines a window 208 that exposes a portion of substrate 204. Substrate 204 can be a silicon substrate and mask 202 can be a photoresist that is spun on, exposed, and developed. Although not illustrated, it is understood that mask 202 may have sidewalls with a re-entry profile.

A thin film 210 is deposited over substrate 204. As a result, thin film 210 collects on mask 202 and the exposed portion of substrate 204. Thin film 210 can be a dielectric (e.g., Si, SiO₂, or TiO₂) deposited by e-beam evaporation or sputtering.

In FIG. 2B, mask 202 is removed to lift off the thin film collected thereon and to leave behind the thin film collected on substrate 204. The remaining thin film forms an optical element 210A. Mask 202 can be chemically removed by a resist stripper.

In FIG. 2C, a lift-off mask 212 is formed over substrate 204. To implement the binary weighted scheme, mask 212 defines a window 218A that exposes a portion of optical element 210A and a portion of substrate 204. Mask 212 also defines a window 218B that exposes another portion of substrate 204. Although not illustrated, it is understood that mask 212 may have sidewalls with a re-entry profile.

A thin film 220 is deposited over substrate 204 and collects on mask 212 and the exposed portions of optical element 210A and substrate 204. To implement the binary weighted scheme, thin film 220 has half the thickness of thin film 210.

In FIG. 2D, mask 212 is removed to lift off the thin film collected thereon and to leave behind the thin film collected on optical element 210A and substrate 204. The remaining thin film forms optical elements 220A, 220B, and 220C. After the use of two masks, a four level structure is formed.

In FIG. 2E, a lift-off mask 222 is formed over substrate 204. To implement the binary weighted scheme, mask 222 defines windows 228A, 228B, 228C, and 228D. Window 228A exposes a portion of optical element 220A. Window 228B exposes a portion of optical element 210A. Window 228C exposes a portion of optical element 220B. Window 228D exposes a portion of optical element 220C and a portion of substrate 204. Although not illustrated, it is understood that mask 222 has sidewalls with a re-entry profile.

A thin film 230 is deposited over substrate 204 and collects on mask 222 and the exposed portions of substrate 204 and optical elements 210A, 220A, 200B, and 220C. To implement the binary weighted scheme, thin film 230 has half the thickness of thin film 220.

In FIG. 2F, mask 222 is removed to lift off the thin film collected thereon and to leave behind the thin film collected on substrate 204 and optical elements 210A, 220A, 220B, and 220C. The remaining thin film forms optical elements 230A, 230B, 230C, 230D, and 230E. After the use of three masks, an eight level structure 200 is formed. In one embodiment, structure 200 is a DOE such as a transmissive grating. Of course a reflective grating can be made if reflective thin films are used.

As described above, the same process can be repeated a number of times to create a stack of optical elements having the desired thicknesses and shapes. Furthermore, the thin film layers may be deposited in the order of increasing thickness instead of decreasing thickness. By depositing the thin films in the order of increasing thickness, the photoresist lift-off masks can be spun on more evenly.

In another embodiment, structure 200 is a mold for fabricating a DOE using a conventional UV replication process.

In another embodiment, structure 200 forms a mold for fabricating a DOE using a conventional injection molding process. In this embodiment, substrate 204 is a metal substrate and thin films 210, 220, and 230 are metal thin films (e.g., Ni).

In another embodiment, structure 200 forms an imprint mask for fabricating a DOE using conventional step and lift imprint lithography. In this embodiment, substrate 204 is a metal substrate and thin films 210, 220, and 230 are metal thin films (e.g., Ni).

In another embodiment illustrated in FIGS. 2G to 2J, structure 200 is a model for a mold used to fabricate a DOE. In this embodiment, substrate 204 is a metal substrate and thin films 210, 220, and 230 are metal thin films (e.g., Cu, Au, or W). In FIG. 2G, a layer of metal 250 is formed over model 200 by plating model 200 with metal 250 (e.g., Ni).

In FIG. 2H, model 200 and substrate 204 are removed to form a mold 250A. Mold 250A defines a cavity 252 having the form of a DOE. Model 200 and substrate 204 can be removed by chemical wet etches. In FIG. 2I, a material is deposited in mold 250A to form a DOE 260. In FIG. 2J, DOE 260 is separated from mold 250A and ready to be used. Depending on its material, DOE 260 can be a transmissive or reflective grating.

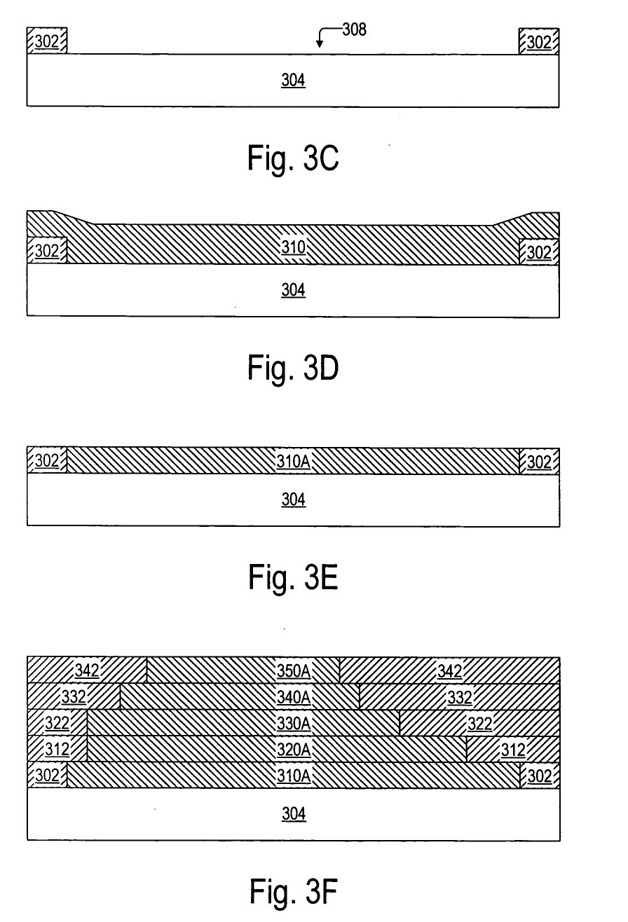

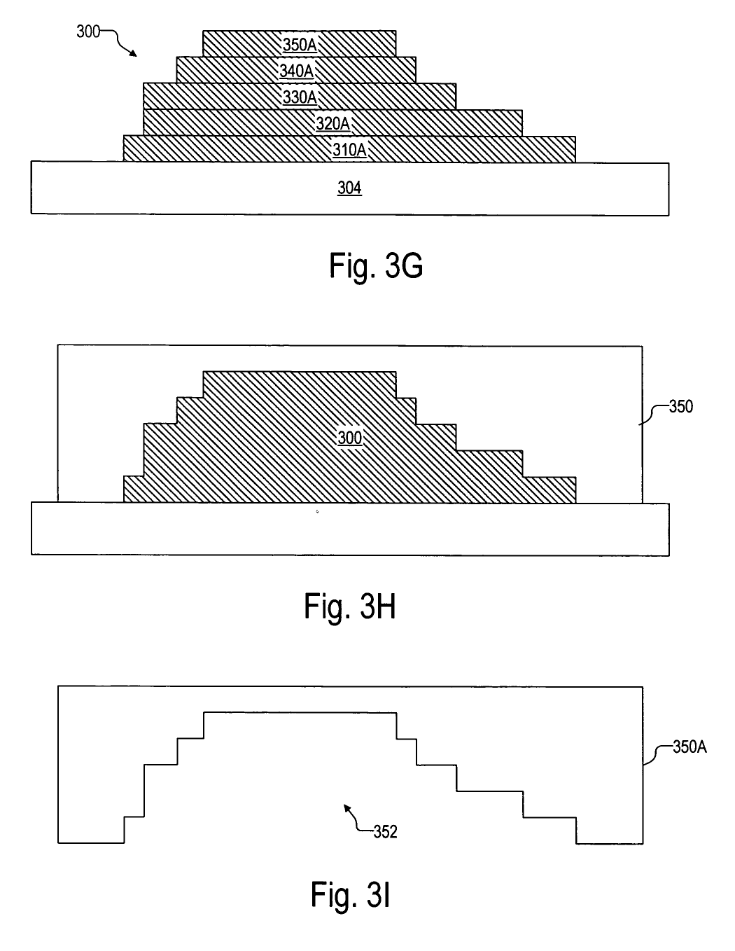

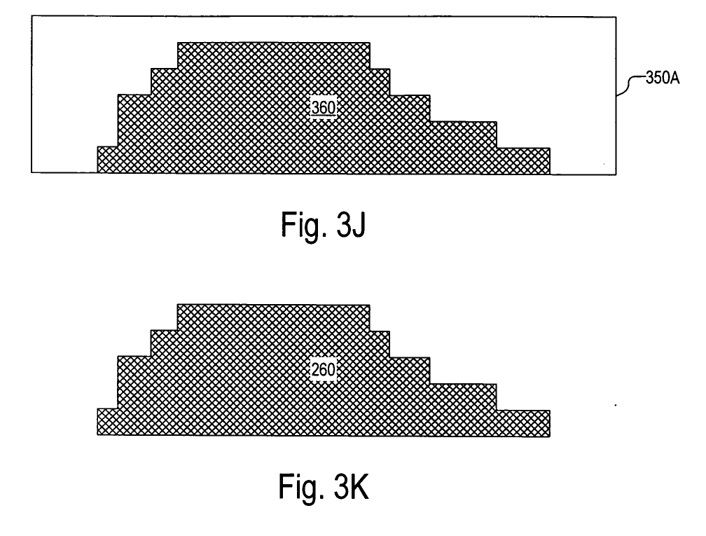

FIGS. 3A to 3G illustrate a Damascene like method for fabricating a DOE in one embodiment of the invention.

In FIG. 3A, an oxide layer 302 is formed on a substrate 304. Oxide layer 302 can be SiO₂ deposited by plasma enhanced chemical vapor deposition (PECVD), and substrate 304 can be a silicon substrate. An etch mask 305 is then formed on oxide layer 302. Etch mask 305 can be a photoresist that is spun on, exposed, and developed. Etch mask 305 defines a window 306 that exposes a portion of oxide layer 302.

In FIG. 3B, the exposed portion of oxide layer 302 is removed. The exposed portion of oxide layer 302 can be removed by dry or wet etching.

In FIG. 3C, etch mask 305 is removed. Etch mask 305 can be chemically removed by a resist stripper. The remaining oxide layer 302 defines a window 308 that exposes a portion of substrate 304

In FIG. 3D, a thin film 310 is deposited over substrate 304. As a result, thin film 310 collects on oxide layer 302 and the exposed portion of substrate 304. Thin film 310 can be Si deposited by PECVD.

In FIG. 3E, oxide layer 302 and thin film 310 are planarized to a desired thickness. Oxide 302 and thin film 310 can be planarized by chemical mechanical polishing (CMP). The remaining thin film forms an optical element 310A.

As described above, the same process can be repeated a number of times to create a stack of optical elements having the desired thicknesses and shapes. The planarized surface provides a smooth surface for spinning on the photoresist etch mask used to form the next optical element. As the process is similar to the Damascene process currently used to form copper conductors in complementary metal oxide semiconductor (CMOS) processing, the thickness (i.e., layer to layer registration) and shape (i.e., feature size) of the optical elements can be controlled with great accuracy (e.g., 0.04 micron and 0.4 micron, respectively).

FIGS. 3F and 3G illustrate a five level structure 300 having optical elements 310A, 320A, 330A, 340A, and 350A formed from the process described above. The remaining oxides 302, 312, 322, and 332 can be optionally removed by dry or wet etching. However, in some circumstances it may be desired to retain the remaining oxides. In one embodiment, structure 300 is a DOE such as transmissive grating. Of course a reflective grating can be made if reflective thin films are used.

In another embodiment, structure 300 is a mold for fabricating a DOE using a conventional UV replication process.

In another embodiment, structure 300 forms a mold for fabricating a DOE using a conventional injection molding process. In this embodiment, substrate 304 is a metal substrate and optical elements 310A, 320A, 330A, 340A, and 350A are made from metal thin films (e.g., Ni).

In another embodiment, structure 300 forms an imprint mask for fabricating a DOE using conventional step and lift lithography. In this embodiment, substrate 304 is a metal substrate and optical elements 310A, 320A, 330A, 340A, and 350A are made from metal thin films (e.g., Ni).

In another embodiment illustrated in FIGS. 3H to 3K, structure 300 is a model for a mold used to fabricate a DOE. In this embodiment, optical elements 310A, 320A, 330A, 340A, and 350A are thin metal films (e.g., Cu, Au, or W). In FIG. 3H, a layer of metal 350 is formed over model 300 by plating model 300 with metal 350 (e.g., Ni).

In FIG. 31, model 300 and substrate 304 are removed to form a mold 350A. Mold 350A defines a cavity 352 having the form of a DOE. Model 300 and substrate 304 can be removed by chemical wet etches. In FIG. 3J, a material is deposited in mold 350A to form a DOE 360. In FIG. 3K, DOE 360 is separated from mold 350A and ready to be used. Depending on its material, DOE 360 can be a transmissive or reflective grating.

The above described processes can be performed in both a CMOS fab and an optoelectronic device fab. The advantage of the CMOS fab is that the DOEs can be made at high volume and with great precision. The advantage of the optoelectronic device fab is that the DOEs can be formed with optoelectronic devices on the same substrate.

Various other adaptations and combinations of features of the embodiments disclosed are within the scope of the invention. Numerous embodiments are encompassed by the following claims.

What is claimed is:

1. A method for making a diffractive optical element, comprising:
forming a first lift-off mask that exposes a portion of a substrate;
depositing a first thin film over the substrate;
removing the first lift-off mask to leave behind a first optical element on the exposed portion of the substrate;
forming a second lift-off mask that exposes a portion of the first optical element;
depositing a second thin film over the substrate; and
removing the second lift-off mask to leave behind a second optical element on the exposed portion of the first optical element.

2. The method of claim 1, wherein the second lift-off mask covers sidewalls of the first optical element.

3. The method of claim 2, wherein:
the first and the second thin films comprise dielectric thin films; and
the first and the second optical elements comprise the diffractive optical element.

4. The method of claim 2, wherein the first and the second optical elements comprise a mold for fabricating the diffractive optical element.

5. The method of claim 2, further comprising:
forming a third lift-off mask that exposes a portion of the second optical element;
depositing a third thin film over the substrate; and
removing the third lift-off mask to leave behind a third optical element on the exposed portion of the second optical element, wherein the third lift-off mask covers sidewalls of the second optical element.

6. The method of claim 1, wherein the second thin film has a different thickness than the first thin film.

7. The method of claim 6, wherein:
said forming a second lift-off mask further exposes a second portion of the substrate; and
said removing the second lift-off mask further leaves behind a third optical element on the second portion of the substrate.

8. The method of claim 7, further comprising:
forming a third lift-off mask that exposes a third portion of the substrate, a second portion of the first optical element, a portion of the second optical element, and a portion of the third optical element;
depositing a fourth thin film over the substrate, wherein the third thin film has a different thickness than the first and the second thin films; and
removing the third lift-off mask to leave behind a fourth optical element on the substrate, a fifth optical element on the first optical element, a sixth optical element on the second optical element, and a seventh optical element on the third optical element.

9. The method of claim 8, wherein:
the first, the second, and the third thin films are dielectric thin films; and
the first, the second, the third, the fourth, the fifth, the sixth, and the seventh optical elements comprise the diffractive optical element.

10. The method of claim 8, wherein the first, the second, the third, the fourth, the fifth, the sixth, and the seventh optical elements comprise a mold for fabricating the diffractive optical element.

11. The method of claim 8, wherein the first, the second, and the third thin films are metal thin films and the first, the second, the third, the fourth, the fifth, the sixth, and the seventh optical elements comprise a model from which a mold of the diffractive optical element is constructed.

12. The method of claim 1, wherein the first and the second thin films are metal thin films and the first and the second optical elements comprise a model from which a mold of the diffractive optical element is constructed.

13. The method of claim 12, further comprising:
forming a metal layer over the model;
removing the substrate and the model to form the mold in the metal layer; and
depositing a material in the mold to form the diffractive optical element.

14. A method for making a diffractive optical element, comprising:
patterning a first material over a substrate to expose a portion of the substrate;
depositing a first thin film over the substrate;
planarizing the first thin film and the first material to form a first optical element;
patterning a second material over the substrate to expose at least a portion of the first optical element;
depositing a second thin film over the substrate; and
planarizing the second thin film and the second material to form a second optical element.

15. The method of claim 14, wherein the first and the second optical elements comprise the diffractive optical element.

16. The method of claim 15, wherein:
the first and the second thin films comprise silicon; and
the first and the second materials comprise silicon dioxide.

17. The method of claim 14, wherein the first and the second optical elements comprise a mold for fabricating the diffractive optical element.

18. The method of claim 14, further comprising:
patterning a third material over the substrate to expose at least a portion of the second optical element;
depositing a third thin film over the substrate; and
planarizing the third thin film and the third material to form a third optical element.

19. The method of claim 14, wherein:
the first and the second thin films are metal thin films; and
the first and the second optical elements comprise a model from which a mold of the diffractive optical element is constructed.

20. The method of claim 19, further comprising:
removing the first and the second materials;
forming a metal layer over the model;
removing the substrate and the model to form the mold; and
depositing a material in the mold to form the diffractive optical element.
